(19) United States
(12) Patent Application Publication
(10) Pub. No.: US 2015/0054358 A1
(43) Pub. Date: Feb. 26, 2015

(54) DEVICE FOR REAR ABUTMENT DETECTION ON A LINEAR ACTUATOR

(71) Applicant: VIRAX, Epernay (FR)

(72) Inventor: Franck DA ROCHA, Puisieulx (FR)

(21) Appl. No.: 14/463,603

(22) Filed: Aug. 19, 2014

(30) Foreign Application Priority Data
Aug. 20, 2013 (FR) 13 58086

(51) Int. Cl. H02K 11/00

(52) U.S. Cl. CPC H02K 11/0073
USPC 310/12.19

(57) ABSTRACT

The invention relates to a linear actuator including a driver for driving a movable assembly between a rest position and an active position, and to an electronic module for controlling the driver. The actuator further includes a damper that damps the return to the rest position of the movable assembly. The electronic module is configured to acquire a representative quantity of the instantaneous force provided by the driver and of the time derivative of this quantity. The electronic module is also able to control the interruption of the operation of the driver if the derivative exceeds a first predetermined value during the phase for returning the movable assembly to the rest position.

### FIELD OF THE INVENTION

The present invention relates to a linear actuator including a driver configured to drive a movable assembly between a rest position and an active position, and an electronic module for controlling the driver.

The invention applies to linear actuators, notably electro-mechanical actuators, intended to receive a tool, for example a removable tool. The tool is actuated by a movable assembly of the actuator. For example, such a tool is a tube-working tool.

### BACKGROUND OF THE INVENTION

It is generally necessary to detect the end-of-travel arrival of the movable assembly, otherwise this may damage the actuator.

FR-A-2 873 514 describes a linear actuator able to actuate a tool by means of a screw driven into translation by an electric motor in both directions along its axis, designated by front and rear directions. This actuator includes sensors, in this case Hall effect sensors, for detecting the passage of a marker secured to the screw, in this case a magnet, and allowing the stopping of the motor when the screw reaches the front and/or rear end of travel.

Nevertheless, such an actuator does not give entire satisfaction. Indeed, the presence of sensors is expressed by additional manufacturing costs and increases the bulkiness and the weight of the actuator.

### SUMMARY OF THE INVENTION

An object of the invention is to propose an actuator for which the number of sensors is reduced.

For this purpose, the object of the invention is an actuator of the aforementioned type, wherein the actuator further includes a damper configured to dampen the return to the rest position of the movable assembly, wherein the electronic module is configured to acquire a representative quantity of the instantaneous force provided by the driver, and the time derivative of this quantity, and wherein the electronic module is able to control interruption of the operation of the driver if said derivative exceeds a first predetermined value during the phrase for returning towards the rest position of the movable assembly.

Indeed, a peak of the derivative of the measured quantity is associated with the abutment of the movable assembly against the damper, which indicates its arrival at the rear end of travel. Interruption in the operation of the driver prevents continuation of the movement of the movable assembly which potentially would have the consequence of damaging the actuator.

According to particular embodiments, the invention has one or several of the following features, taken individually or according to any technically possible combination:

the electronic module is able to control the interruption of the operation of the driver if said quantity exceeds a second predetermined value, during the phase for returning to the rest position of the movable assembly.

the damper includes a deformable damper and with a converging shape forwards along a displacement axis of the movable assembly.

the electronic module is able to control the driver so that the speed of the movable assembly during the phase for returning from the active position to the rest position is decreasing over at least one portion of said return phase.

the phase for returning to the rest position includes a first backward step with a first predetermined time period and a second step for bringing it to rest, and the speed of the movable assembly during the first step is substantially constant and on average greater than the average speed of the movable assembly during the second step.

said driver includes an electric motor, and said quantity is the instantaneous intensity of the power supply current of the motor.

the actuator is powered by a battery.

The electronic module is configured to modify said first predetermined time period, according to the charge level of the battery.

### BRIEF DESCRIPTION OF THE DRAWINGS

The invention will be better understood by means of the description which follows, only given as an example and made with reference to the appended drawings wherein:

FIG. 1 is a schematic illustration of an actuator according to the invention;

FIG. 2 is a block diagram of the electronic module of the actuator of FIG. 1;

FIG. 3 is a graph illustrating the curve of the intensity consumed by the actuator of FIG. 1 and of the time derivative of this intensity, during a phase for returning to the rest position.

### BRIEF DESCRIPTION OF THE DRAWINGS

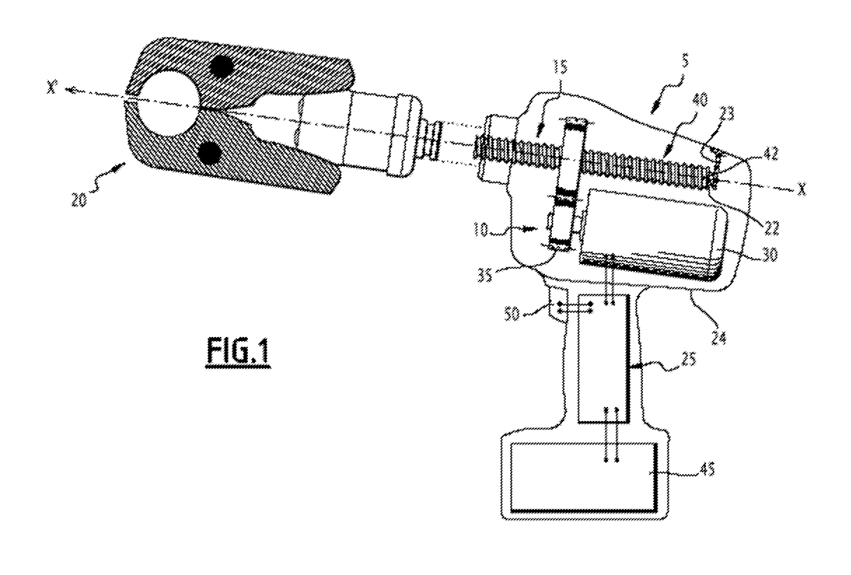

As this appears in FIG. 1, a linear actuator 5 includes means 10 for driving a movable assembly 15 along a longitudinal axis X-X′ in order to actuate a tool 20, for example a removable tool.

The tool 20 is for example a tube-working tool.

The actuator also includes a damper 22. The damper 22 is positioned in the actuator and is crossed by the X-X′ axis. For example, the damper 22 is attached or to a support 23 secured to the body 24 of the actuator 5.

Advantageously, the damper 22 has a forward converging shape in the direction X-X′. Preferably, the damper 22 is made in a deformable material. For example, the damper 22 is a rubber spherical cap.

The driver 10 is controlled by an electronic module 25. The driver 10, the movable assembly 15 and the electronic module 25 are positioned in the body 24 of the actuator 5.

For example, the driver 10 is formed with an electric motor 30, for example a DC motor, and a reduction gear 35.

For example, the movable assembly 15 is a screw 40 extending along the longitudinal axis X-X′. The screw 40 is driven into translation along the axis X-X′ by the motor 30, via the reduction gear 35, between an advance position of the screw 40 out of the body 24 of the actuator 5, a so-called active position, and a backward position, a so-called rest position, illustrated in FIG. 1, wherein a rear portion 42 of the screw 40 is in contact with the damper 22.

The electronic module 25 in particular controls the electric power supply of the motor 30 provided by a power source, for example a battery 45.

The actuator 5 also includes a manual switch 50 four allowing the user to control the movements of the actuator 5. The manual switch 50 for example allows triggering of the return of the movable assembly 15 into the rest position.

The manual switch 50 is connected to the electronic module 25.

Preferably, the electronic module 25 is also able to control the return of the movable assembly 15 into the rest position, for example after the movable assembly 15 has spent a predetermined time period in the active position.

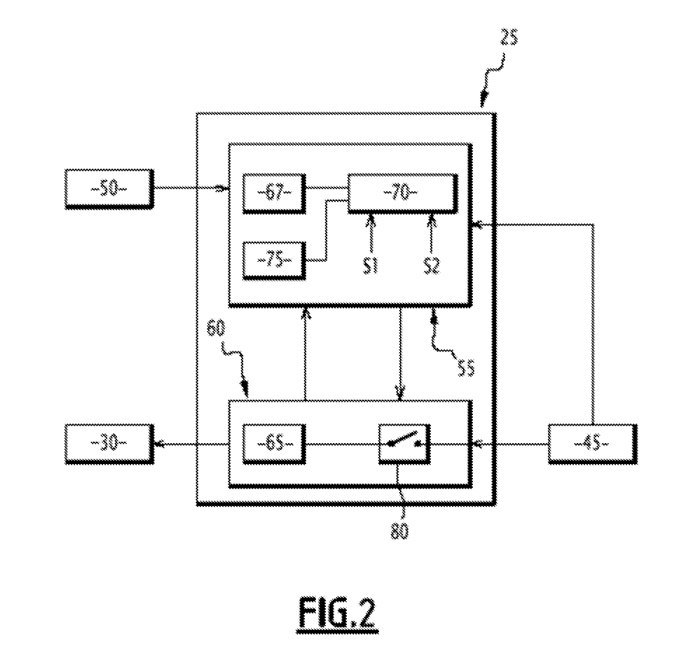

As this is apparent in FIG. 2, the electronic module 25 includes a control module 55 connected to a power module 60.

The power module 60 ensures the management of the electric power supply of the motor 30 and is interposed between the battery 45 and the motor 30.

The power module 60 comprises means 65 for acquiring the instantaneous intensity of the power supply current of the motor 30.

The switch 50 is connected to the control module 55.

The control module 55 includes means 67 for calculating the time derivative of the intensity of the power supply current.

The control module 55 further includes means 70 four comparing the time derivative of the intensity of the power supply current with a first predetermined value S1 and of the intensity of this current with a second predetermined value S2, in order to actuate a main switch 80 four cutting off the power supply of the motor 30 if the derivative of the intensity of the power supply current, respectively the intensity of this current, becomes greater than the first predetermined value S1, respectively the second predetermined value S2, during a return phase of the movable assembly 15 into the rest position, on the conditions described later on.

The control module 55 also includes a clock 75 for measuring the elapsed time since the beginning of the return phase into the rest position of the movable assembly 15.

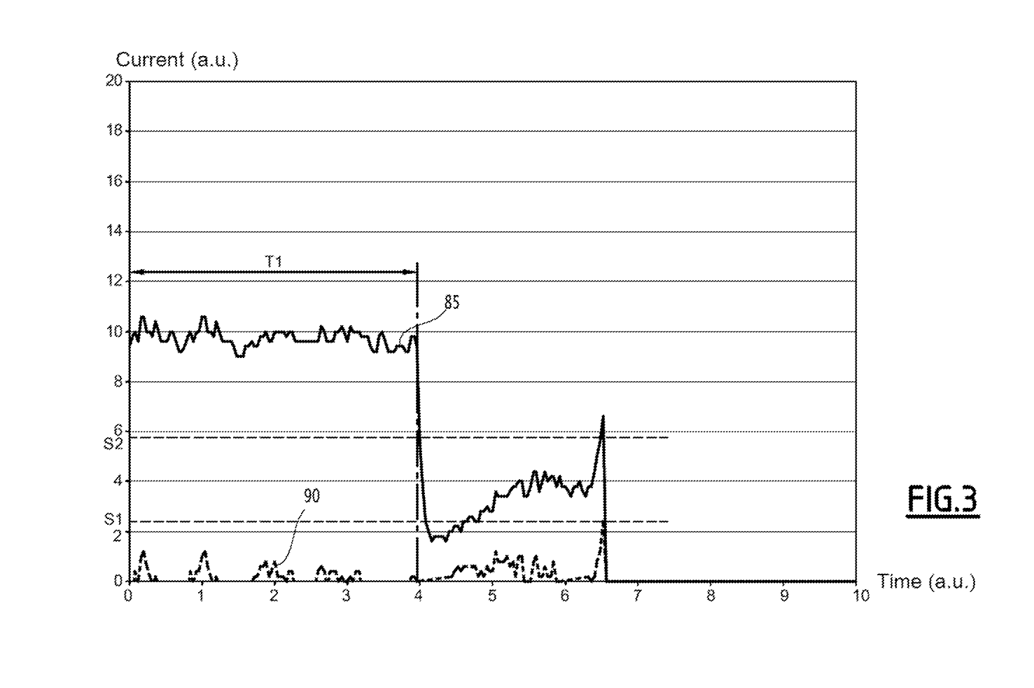

The operation of the actuator 5 will be explained in connection with FIG. 3.

FIG. 3 illustrates the variation over time of the power supply current of the motor 30, curve 85, and of the time derivative of this current, curve 90, as a result of the triggering, for example via the manual switch 50, of the return of the movable assembly 15 into the rest position from the active position. In a DC electric motor, as the intensity of the power supply current of the motor and the force provided by the latter are proportional to each other, the curves 85 and 90 are well representative of the force provided by the motor 30 and of the time derivative of this force, respectively.

During the return phase to the rest position from the active position, the screw 40 advances in the body 24 of the actuator 5, the rear portion 42 of the screw 40 getting closer to the damper 22. Preferably, the electronic module 25 controls the motor 30 in order to drive the screw 40 during a first backward step with a first predetermined time period T1 at a first speed v1, for example a constant speed v1.

At the end of the first predetermined time period T1, for example 3.9 time units, the electronic module 25 controls the motor 30 in order to drive the screw 40 towards the rest position at a second speed v2 during a second step for bringing it to rest.

Advantageously, the speed v1 is a less than the speed v2 for allowing rapid return of the screw 40 into the rest position and thereby reducing the duration of the cycle of use of the actuator 5, while limiting the impact speed of the rear portion 42 of the screw 40 against the damper 22.

When the rear portion 42 of the screw 40 comes into contact with the damper 22, the motor 30 provides an additional force in order to compensate for the resistance of the damper 22, which is expressed by an increase in the power supply current of the motor 30 and a change in its time derivative, as this appears in curves 85 and 90 respectively, from 6.3 time units.

When, at 6.5 time units, the value of the derivative of the intensity of the power supply current of the motor 30 exceeds the first predetermined value S1, and the value of the intensity of the power supply current of the motor 30 exceeds the second predetermined value S2, the comparison means 70 actuate the main switch 80.

Preferably, the first predetermined time period T1 depends on the charge level of the battery 45. For example, the first predetermined time period T1 is a decreasing linear function of the charge of the battery 45, in order to compensate the drop of the power provided by the battery 45 during its discharge.

Resorting to a damper 22 in a deformable material limits the amplitude of the intensity and intensity derivative peaks, which allows better protection of the motor 30.

Further, because of the convergent shape of the damper 22 along the X-X′ axis, the contact surface area between the rear portion 42 of the screw 40 and the damper 22 is small, which reduces the torque exerted on the damper 22 and increases its lifetime.

According to another embodiment (not shown) of an actuator according to the invention, the driver 10 includes a hydraulic means, for example a cylinder. The electronic module 25 for example is configured to acquire a quantity depending on the instantaneous force provided by the cylinder, for example the pressure of the fluid powering the cylinder.

What is claimed is:

1. A linear actuator comprising a driver configured to drive a movable assembly between a rest position and an active position, and an electronic module for controlling the driver,
wherein the actuator further comprises a damper configured to dampen the return into the rest position of the movable assembly, wherein the electronic module is configured to acquire a quantity that is representative of the instantaneous force provided by the driver, and of the time derivative of this quantity, and wherein the electronic module is configured to control interruption of the operation of the driver if said derivative exceeds a first predetermined value during the return phase for returning the movable assembly to the rest position.

2. The actuator according to claim 1, wherein the electronic module is able to control the interruption if said quantity exceeds a second predetermined value, during the return phase for returning the movable assembly to the rest position.

3. The actuator according to claim 1, wherein the damper comprises a deformable damper having a forward convergent shape along a displacement axis of the movable assembly.

4. The actuator according to claim 1, wherein said driver comprises an electric motor, and wherein said quantity is the instantaneous intensity of the power supply current of the motor.

5. The actuator according to claim 1, wherein the actuator is powered by a battery.

6. The actuator according to claim 5, wherein the electronic module is configured to modify said predetermined time period depending on the charge level of the battery.

7. The actuator according to claim 1, wherein the electronic module is able to control the driver so that the speed of the movable assembly during the return phase for returning from the active position to the rest position is decreasing over at least one portion of said return phase.

8. The actuator according to claim 7, wherein the return phase includes a first backward step of a predetermined time period and a second step for bringing the movable assembly to the rest position, and wherein the speed of the movable assembly during the first step is substantially constant and on average greater than the average speed of the movable assembly during the second step.

9. The actuator according to claim 7, wherein said driver comprises an electric motor, and wherein said quantity is the instantaneous intensity of the power supply current of the motor.

10. The actuator according to claim 7, wherein the actuator is powered by a battery.

11. The actuator according to claim 10, wherein the electronic module is configured to modify said predetermined time period depending on the charge level of the battery.
